(19) United States
(12) Patent Application Publication
(10) Pub. No.: US 2011/0294083 A1
(43) Pub. Date: Dec. 1, 2011

(54) Molten Salt Treatment System and Process

(75) Inventors: James Edwin Wiley, Moraga, CA (US); William Akers, Saraland, AL (US); William R. Skelding, Sycamore, IL (US)

(73) Assignee: TATE & LYLE TECHNOLOGY LIMITED, LONDON (GB)

(21) Appl. No.: 13/142,555

(22) PCT Filed: Dec. 29, 2009
(86) PCT No.: PCT/GB2009/002964

§ 371 Date: Aug. 17, 2011

Related U.S. Application Data
(60) Provisional application No. 61/141,110, filed on Dec. 29, 2008.

(51) Int. Cl. F24J 3/00; B01J 19/00

(52) U.S. Cl. 432/5; 422/129; 422/187; 422/168; 432/1

(57) ABSTRACT

A molten salt treatment system and process can include one or more tubular conduits flowably connected to a molten salt reactor, the tubular conduit containing concentrically within it a pipe or a shaft separated by an annular space therebetween, and one or more gas sources connected to feed gas into the annular space. The system may include a scrubbing device flowably connected to a molten salt reactor off-gas outlet to receive an off-gas, a first heating device configured to heat the effluent from the scrubbing device, and a filtering device flowably connected to receive the effluent from the heating device. An overflow conduit may be flowably connected to a molten salt reactor overflow outlet to receive molten salt therefrom and discharge the molten salt to a salt recovery vessel, and a blower or other gas mover may be connected to the molten salt reactor and the recovery vessel to prevent backflow of cold gases through the overflow outlet to the molten salt reactor.

### FIELD OF THE INVENTION

The present invention is directed to a molten salt treatment system and process. More specifically, the present invention is directed to molten salt reactor feed delivery, off-gas treatment, and spent salt removal systems and processes.

### BACKGROUND OF THE INVENTION

Molten salt treatment systems can be used for oxidizing organic compounds, for example chlorinated organic materials to form carbon dioxide, water and salt. Unfortunately, their industrial utility has been limited by difficulties in scaling the systems to sufficiently large size so as to be useful for large-scale operations. In particular, there have been significant difficulties in introducing the feed material to be oxidized into the reactors without plugging the feed ports, as well as difficulties in removing the salt(s) generated during operation without plugging the exit ports. Thus, methods and devices to address the problems of large scale molten salt reactor use, for oxidation and other purposes, would be of benefit.

### SUMMARY OF THE INVENTION

In one aspect, the invention provides:

Item 1: A molten salt treatment system including:

a molten salt reactor including a vessel containing a molten salt;

one or more tubular conduits flowably connected to the molten salt reactor, each of the tubular conduits containing concentrically within it a corresponding pipe or shaft so as to form an annular space therebetween; and

one or more gas sources connected to feed a gas through the annular space in at least one of the tubular conduits into the reactor.

The one or more tubular conduits may be connected to a side of the molten salt reactor, with the tubular conduit extending substantially transversely with respect to a reactor axis.

According to this aspect, the invention may provide:

Item 2: The system of item 1 wherein said one or more tubular conduits is connected, preferably with the tubular conduit extending substantially transversely with respect to a reactor axis, to the molten salt reactor, preferably to a side thereof, at a location below a liquid level of molten salt in the molten salt reactor.

Item 3: The system of item 1 further comprising a first sealing device at an upstream location in at least one of said one or more tubular conduits, and a second sealing device in said at least one tubular conduit at a downstream location.

Item 4: The system of item 3 wherein said second sealing device is a valve having open and closed positions.

Item 5: The system of item 4 wherein said first sealing device comprises a packing gland.

Item 6: The system of item 1 wherein said pipe or shaft further comprises a stop limit.

Item 7: The system of item 6 wherein said stop limit comprises a coupling.

Item 8: The system of item 1 wherein in at least one of said one or more tubular conduits, said pipe or shaft is a pipe connected to a feed source to feed a material to the molten salt reactor.

Item 9: The system of item 8 wherein said material comprises halogenated waste material.

Item 10: The system of item 9 wherein said material comprises chlorinated waste material from a sucralose manufacturing process.

Item 11: The system of item 1 wherein said pipe or shaft is a shaft.

Item 12: The system of item 11 wherein said shaft comprises a drill bit mounted onto a downstream end of said pipe or shaft.

Item 13: The system of item 1 wherein at least one of the tubular conduits contains a pipe and at least one other tubular conduit contains a shaft.

Item 14: The system of item 1 wherein said gas comprises air.

Item 15: The system of item 1 further comprising an evaporating device flowably connected to said one or more tubular conduits upstream of said one or more tubular conduits.

Item 16: The system of item 1 wherein said pipe or shaft is a pipe connected to receive molten salt discharged from the molten salt reactor and to discharge the molten salt to a salt recovery vessel.

In another aspect, the invention provides:

Item 17: A molten salt treatment system including:

a molten salt reactor including a vessel capable of containing a molten salt, the vessel flowably attached to an off-gas outlet;

a scrubbing device flowably connected to the off-gas outlet to receive an off-gas containing entrained salt therefrom;

a heating device configured to heat the gaseous effluent from the scrubbing device; and

a filtering device flowably connected to receive the gaseous effluent from the heating device.

The off-gas outlet may be connected to the top of the molten salt reactor, with the off-gas outlet extending substantially longitudinally with respect to a reactor axis (that is, substantially parallel to the reactor axis).

According to this aspect, the invention may provide:

Item 18: The system of item 17 wherein said scrubbing device is a water scrubber.

Item 19: The system of item 17 wherein said scrubbing device comprises a venturi scrubber.

Item 20: The system of item 17 wherein said heating device comprises a direct-heating device.

Item 21: The system of item 20 wherein said heating device is a gas burner.

Item 22: The system of item 17 wherein said heating device comprises an indirect heating device.

Item 23: The system of item 22 wherein said heating device is a heat exchanger.

Item 24: The system of item 17 wherein said heating device heats said gaseous effluent to a temperature above the saturation temperature of the gaseous effluent.

Item 25: The system of item 17 wherein said filtering device comprises a baghouse.

In another aspect, the invention provides

Item 26: A molten salt treatment system including:

a molten salt reactor including a vessel capable of containing a molten salt, the vessel flowably attached to a reactor overflow outlet;

an overflow conduit flowably connected to the reactor overflow outlet to receive molten salt therefrom and discharge the molten salt to a salt recovery vessel; and

a gas mover flowably connected to the molten salt reactor and the salt recovery vessel and capable of preventing backflow of cold gases through the overflow conduit to the molten salt reactor.

The overflow conduit may be connected to a side of the molten salt reactor, with the overflow conduit extending substantially transversely with respect to a reactor axis.

According to this aspect, the invention may provide:

Item 27: The system of item 26 wherein the gas mover comprises a superheated steam injector.

Item 28: The system of item 26 wherein said molten salt reactor further comprises a splash shield positioned at said overflow conduit.

Item 29: The system of item 26 wherein said overflow conduit is sloped back toward said molten salt reactor.

Item 30: The system of item 26 further comprising a heating device connected to introduce hot gas into said overflow conduit.

Item 31: The system of item 30 wherein said heating device comprises a direct heating device.

Item 32: The system of item 31 wherein said direct heating device is a gas burner.

Item 33: The system of item 30 wherein said heating device comprises an indirect heating device.

Item 34: The system of item 33 wherein said indirect heating device is a heat exchanger.

Item 35: The system of item 26 further comprising a salt dissolution device flowably connected to receive the molten salt from the reactor, dissolve the salt in water, and transport the salt to the salt recovery vessel.

Item 36: The system of item 35 wherein said salt dissolution device comprises a sluice line.

Item 37: The system of item 26 further comprising one or more directional superheated steam injectors located to impinge and break up molten salt issuing from said overflow conduit and to direct the molten salt to the salt recovery vessel.

Item 38: The system of item 26 wherein said gas mover comprises a blower having a low pressure side flowably connected to the salt recovery vessel and a high pressure side flowably connected to the molten salt reactor.

In yet another aspect, the invention provides:

Item 39: A molten salt treatment system including:

a molten salt reactor including a vessel capable of containing a molten salt, the vessel flowably attached to an off gas outlet and to a reactor overflow outlet;

one or more tubular conduits flowably connected to the molten salt reactor, each of the tubular conduits containing concentrically within it a corresponding pipe or shaft so as to form an annular space therebetween;

one or more gas sources connected to feed a gas through the annular space in at least one of the tubular conduits into the reactor;

a scrubbing device flowably connected to the off-gas outlet to receive therefrom an off-gas containing entrained salt;

a first heating device configured to heat a gaseous effluent from the scrubbing device;

a filtering device flowably connected to receive the gaseous effluent heated by the heating device;

an overflow conduit flowably connected to the reactor overflow outlet to receive molten salt therefrom and discharge the molten salt to a salt recovery vessel; and

a gas mover flowably connected to the molten salt reactor and the salt ao recovery vessel capable of preventing backflow of cold gases through the overflow conduit to the molten salt reactor.

The one or more tubular conduits may be connected to a side of the molten salt reactor, with the tubular conduit extending substantially transversely with respect to a reactor axis.

The off-gas outlet may be connected to the top of the molten salt reactor, with the off-gas outlet extending substantially longitudinally with respect to a reactor axis.

The overflow conduit may be connected to a side of the molten salt reactor, with the overflow conduit extending substantially transversely with respect to a reactor axis.

According to this aspect, the invention may provide:

Item 40: The system of item 39 wherein said one or more tubular conduits is connected, preferably with the tubular conduit extending substantially transversely with respect to a reactor axis, to the molten salt reactor, preferably to a side thereof, at a location below a liquid level of molten salt in the molten salt reactor.

Item 41: The system of item 39 further comprising a first sealing device at an upstream location in at least one of said one or more tubular conduits, and a second sealing device in said at least one tubular conduit at a downstream location.

Item 42: The system of item 41 wherein said second sealing device is a valve having open and closed positions.

Item 43: The system of item 42 wherein said first sealing device comprises a packing gland.

Item 44: The system of item 39 wherein said tubular conduit further comprises a stop limit in a portion of said one or more tubular conduits.

Item 45: The system of item 44 wherein said stop limit comprises a coupling.

Item 46: The system of item 39 wherein in at least one of said one or more tubular conduits, said pipe or shaft is a pipe connected to a feed source to feed a material to said molten salt reactor.

Item 47: The system of item 46 wherein said one or more gas sources feed a gas into said at least one tubular conduit at a pressure sufficient to prevent backflow of molten salt into said tubular conduit.

Item 48: The system of item 46 wherein said material comprises halogenated waste material.

Item 49: The system of item 48 wherein said material comprises chlorinated waste material from a sucralose manufacturing process.

Item 50: The system of item 39 wherein said pipe or shaft is a shaft.

Item 51: The system of item 50 wherein said pipe or shaft comprises a drill bit mounted onto a downstream end of said pipe or shaft.

Item 52: The system of item 39 wherein said one or more tubular conduits comprise at least one tubular conduit concentrically containing a pipe and at least another tubular conduit concentrically containing a shaft.

Item 53: The system of item 39 wherein said gas comprises air.

Item 54: The system of item 39 further comprising an evaporating device flowably connected to said one or more tubular conduits upstream of said one or more tubular conduits.

Item 55: The system of item 39 wherein said pipe or shaft is a pipe connected to receive molten salt discharged from said molten salt reactor and to discharge the molten salt to the salt recovery vessel.

Item 56: The system of item 39 wherein said scrubbing device is a water scrubber.

Item 57: The system of item 39 wherein said scrubbing device comprises a venturi scrubber.

Item 58: The system of item 57 wherein said first heating device comprises a direct-heating device.

Item 59: The system of item 54 wherein said first heating device is a gas burner.

Item 60: The system of item 39 wherein said first heating device comprises an indirect heating device.

Item 61: The system of item 60 wherein said first heating device is a heat exchanger.

Item 62: The system of item 39 wherein said first heating device is capable of heating said gaseous effluent to a temperature above the saturation temperature of the gaseous effluent.

Item 63: The system of item 39 wherein said filtering device comprises a baghouse.

Item 64: The system of item 39 wherein the gas mover comprises a superheated steam injector.

Item 65: The system of item 39 wherein said molten salt reactor further comprises a splash shield positioned at said overflow conduit.

Item 66: The system of item 39 wherein said overflow conduit is sloped back toward said molten salt reactor.

Item 67: The system of item 39 further comprising a second heating device connected to introduce hot gas into said overflow conduit.

Item 68: The system of item 67 wherein said second heating device comprises a direct heating device.

Item 69: The system of item 68 wherein said second heating device is a gas burner.

Item 70: The system of item 67 wherein said second heating device comprises an indirect heating device.

Item 71: The system of item 70 wherein said second heating device is a heat exchanger.

Item 72: The system of item 39 further comprising a salt dissolution device flowably connected to receive the molten salt from said heating device and connected to transport dissolved salt to the salt recovery vessel.

Item 73: The system of item 72 wherein said salt dissolution device comprises a sluice line.

Item 74: The system of item 39 further comprising one or more directional superheated steam injectors configured to receive molten salt from said overflow conduit and to direct the molten salt to the salt recovery vessel.

Item 75: The system of item 39 wherein said gas mover comprises a blower having a low pressure side flowably connected to the dissolution vessel and a high pressure side flowably connected to said molten salt reactor.

In yet another aspect, the invention provides:

Item 76: A process for treating a material in a molten salt reactor, the reactor including a vessel containing a molten salt, the process including the steps of:

delivering the material via a pipe concentrically contained within a tubular conduit flowably connected to the molten salt reactor, the pipe and conduit forming an annular space therebetween; and

injecting a gas into the annular space, the gas having a pressure sufficient to prevent molten salt from backflowing out of the molten salt reactor into the annular space.

The tubular conduit may be connected to a side of the molten salt reactor, with the tubular conduit extending substantially transversely with respect to a reactor axis.

According to this aspect, the invention may provide:

Item 77: The process of item 76 further comprising the step of removing a solvent from the material in an amount sufficient to prevent overpressurization when the material is introduced into the molten salt reactor under operating conditions.

Item 78: The process of item 77 wherein said solvent is water.

Item 79: The process of item 78 wherein the step of removing a solvent comprises evaporating the water from the material.

Item 80: The process of item 76 further comprising the step of heating the material prior to delivering the material to the molten salt reactor.

Item 81: The process of item 76 wherein the gas comprises air.

In a further aspect, the invention provides:

Item 82: A process for treating off-gas from a molten salt reactor, the reactor including a vessel containing a molten salt, the process including the steps of:

scrubbing an off-gas containing solid particulate matter discharged from the molten salt reactor with an aqueous stream to remove at least a portion of the particulate matter and produce a moisture-containing gaseous effluent;

heating the moisture-containing gaseous effluent; and

filtering the effluent to remove remaining entrained solid particulate matter.

According to this aspect, the invention may provide:

Item 83: The process of item 82 wherein said scrubbing step comprises scrubbing with a venturi scrubber.

Item 84: The process of item 82 wherein the solid particulate matter comprises particles of a salt.

Item 85: The process of item 82 wherein the step of heating the moisture-containing gaseous effluent includes heating a water saturated gaseous effluent to a temperature above a saturation temperature of the effluent.

Item 86: The process of item 82 further comprising venting the gaseous effluent to the atmosphere.

In yet a further aspect, the invention provides:

Item 87: A process for discharging molten salt from a molten salt reactor, the reactor including a vessel containing a molten salt, the process including the steps of:

heating or maintaining a temperature of a molten salt stream discharged from the molten salt reactor to a salt recovery vessel to maintain the molten salt stream in a molten state; and

operating a gas mover to prevent backflow of cold gases to the molten salt reactor.

According to this aspect, the invention may provide:

Item 88: The process of item 87 further comprising dissolving the molten salt stream in water prior to introducing the salt to the salt recovery vessel.

Item 89: The process of item 88 wherein the step of dissolving the molten salt overflow stream includes dissolving the molten salt in water in a sluice line.

Item 90: The process of item 87 further comprising the step of directing the molten salt overflow stream to the salt recovery vessel using one or more directional superheated steam injectors.

Item 91: The process of item 87 wherein said step of generating conditions comprises generating a pressure, temperature or combination thereof to prevent backflow of cold gases to the molten salt reactor.

Item 92: The process of item 87 wherein the step of generating a pressure comprises generating a low pressure in the dissolution recovery vessel and a high pressure in the molten salt reactor with a blower.

Item 93: The process of item 87 further comprising recovering salt from the molten salt reactor as a salt solution.

Item 94: The process of item 87 further comprising recovering salt from the molten salt reactor as a solid.

Item 95: The process of item 87 further comprising maintaining a splash shield at an outlet of said molten salt reactor.

Item 96: The process of item 87 further comprising limiting flow discharged from said molten salt reactor via a restriction neck downstream of said molten salt reactor.

In an additional aspect, the invention provides:

Item 97: A process for treating a material in a molten salt reactor, the reactor including a vessel containing a molten salt and the vessel flowably connected to a reactor overflow outlet, the process including the steps of:

delivering the material to the molten salt reactor via a pipe concentrically contained within a tubular conduit flowably connected to the reactor, the pipe and the conduit forming an annular space therebetween;

injecting a gas into the annular space, the gas having a pressure sufficient to prevent molten salt from backflowing out of the molten salt reactor into the tubular conduit or the pipe;

scrubbing an off-gas containing solid particulate matter discharged from the molten salt reactor with an aqueous stream to remove at least a portion of the particulate matter and produce a moisture-containing gaseous effluent;

heating the moisture-containing gaseous effluent;

filtering the effluent to remove remaining entrained solid particulate matter;

discharging molten salt from the reactor to a salt recovery vessel through an overflow conduit flowably connected to the reactor overflow outlet; and

operating a gas mover flowably connected to the molten salt reactor and the salt recovery vessel to prevent backflow of cold gases through the overflow conduit to the molten salt reactor.

The tubular conduit may be connected to a side of the molten salt reactor, with the tubular conduit extending substantially transversely with respect to a reactor axis.

According to this aspect, the invention may provide:

Item 98: The process of item 97 further comprising the step of removing a solvent from the material in an amount sufficient to prevent overpressurization when the material is introduced into the molten salt reactor under operating conditions.

Item 99: The process of item 98 wherein said solvent is water.

Item 100: The process of item 98 wherein the step of removing a solvent comprises evaporating the water from the material.

Item 101: The process of item 97 further comprising the step of heating the material prior to delivering the material to the molten salt reactor.

Item 102: The process of item 97 further comprising the step of maintaining an airlock in a portion of the tubular conduit.

Item 103: The process of item 97 wherein the gas comprises air.

Item 104: The process of item 97 wherein the scrubbing step comprises scrubbing with a water scrubber.

Item 105: The process of item 97 wherein said scrubbing step comprises scrubbing with a venturi scrubber.

Item 106: The process of item 97 wherein the solid particulate matter comprises salt.

Item 107: The process of item 97 wherein the step of heating the moisture-containing gaseous effluent includes heating a water saturated gaseous effluent to a temperature above a saturation temperature of the effluent.

Item 108: The process of item 97 further comprising venting the gaseous effluent to atmosphere.

Item 109: The process of item 97 further comprising dissolving the molten salt stream in water prior to introducing the salt to the salt recovery vessel

Item 110: The process of item 109 wherein the step of dissolving the molten salt overflow stream includes dissolving the molten salt in water in a sluice line.

Item 111: The process of item 97 further comprising the step of directing the molten salt overflow stream to the salt recovery vessel using one or more directional superheated steam injectors.

Item 112: The process of item 97 wherein said step of generating conditions comprises generating a pressure, temperature or combination thereof to prevent backflow of cold gases to the molten salt reactor.

Item 113: The process of item 97 wherein the step of generating conditions comprises generating a low pressure in the salt recovery vessel and a high pressure in the molten salt reactor with a blower.

Item 114: The process of item 97 further comprising recovering salt from the molten salt reactor in a salt solution.

Item 115: The process of item 97 further comprising recovering salt from the molten salt reactor as a solid.

Item 116: The process of item 97 further comprising limiting flow discharged from said molten salt reactor via a restriction neck downstream of said molten salt reactor.

The present invention may also provide, in relation to embodiments described above:

Item 117: The system of item 9 further comprising a nozzle on the downstream end of the pipe, said nozzle comprising a plurality of passages passing from the upstream end of the nozzle into the interior of the pipe and terminating near the downstream end thereof.

Item 118: The system of item 9 wherein the passages are oriented in an inwardly twisting direction.

Item 119: The system of item 1 further comprising a shield surrounding at least a portion of the vessel, located and shaped so as to define an annular ventilation space between the shield and the vessel.

Item 120: The process of item 76 further comprising introducing a combustible gas or vapor into the reactor below or above a surface of the molten salt, or both.

In yet another aspect, the invention provides:

Item 121: A process for treating a material in a molten salt reactor, the reactor including a vessel containing a molten salt, the process including the steps of:

delivering the material into the reactor; and

discharging molten salt from the reactor through a pipe to a salt recovery vessel, the pipe contained concentrically within a tubular conduit flowably connected to the reactor, the pipe and conduit forming an annular space therebetween; and

injecting a gas into the annular space, the gas having a pressure sufficient to prevent molten salt from backflowing out of the molten salt reactor into the annular space.

The tubular conduit may be connected to a side of the molten salt reactor, with the tubular conduit extending substantially transversely with respect to a reactor axis.

The reactor axis, as the term is used herein, is suitably substantially vertical.

As the molten salt treatment system of the present invention in all embodiments comprises a molten salt reactor which will be located on, or mounted with respect to, a surface (for example the ground), the reactor axis, as used herein, is preferably substantially normal to the surface.

Furthermore, as herein defined and described, the molten salt reactor will comprise a base, substantially in contact with the surface; one or more sides (depending on the shape of the molten salt reactor) extending from the base in a direction normal to the base; and a top, distal to the surface, and so “base”, “side” and “top” are used herein with that meaning.

The material that can be treated according to the processes of the present invention in all embodiments is not particularly limited provided that it is flowable, in the sense that it can be delivered to the molten salt reactor via a pipe. It may be, for example, a solid, a liquid, a gas, including a suspension or slurry of solids in a liquid or a gas, and a mixture of liquids. However, the processes of the present invention are particularly suitable for treating materials other than gases, so that the material is advantageously a solid, a liquid, a suspension or slurry of solids in a liquid, or a mixture of liquids. The materials that can be treated are described in more detail hereinafter.

### BRIEF DESCRIPTION OF THE DRAWINGS

The invention is best understood from the following detailed description when read in connection with the accompanying drawings. It is emphasized that, according to common practice, the various features of the drawing are not rendered to scale. On the contrary, the dimensions of the various features are arbitrarily expanded or reduced for clarity. Included in the drawing are the following figures, in which like reference numerals refer to similar features in the respective Figures:

FIG. 1A is a block diagram of an exemplary embodiment of a molten salt oxidation treatment system according to some aspects of the present invention.

FIG. 1B is a block diagram of an another exemplary embodiment of a molten salt oxidation treatment system according to the present invention.

FIG. 2 is a schematic of an embodiment of a molten salt oxidation treatment delivery system according to an exemplary aspect of the present invention.

FIG. 3 is a schematic of yet another exemplary embodiment of a molten salt oxidation treatment delivery system according to some aspects of the present invention.

FIG. 4A is a side view schematic of an exemplary delivery device in accordance with some aspects of the present invention.

FIG. 4B is a side cross-sectional view of an exemplary feed nozzle positioned in a tubular conduit in accordance with an exemplary embodiment of the present invention.

FIG. 4C is a side view of an exemplary feed nozzle according to an exemplary embodiment of the present invention.

FIG. 4D is an end cross-sectional view along lines D-D of the feed nozzle of FIG. 4A.

FIG. 5 is a side view schematic of another exemplary delivery device in accordance with an exemplary embodiment of the present invention.

FIG. 6 is a schematic of an exemplary embodiment of a molten salt oxidation treatment salt recovery system according to an aspect of the present invention.

FIG. 7 is a schematic of an exemplary embodiment of a molten salt oxidation treatment off-gas treatment system according to another aspect of the present invention

FIG. 8 is a schematic of another exemplary embodiment of a molten salt oxidation treatment off-gas treatment system according to another aspect of the present invention.

FIG. 9 is a schematic of an exemplary embodiment of a molten salt oxidation treatment salt recovery system according to yet another aspect of the present invention

FIG. 10A is a schematic of another exemplary embodiment of a molten salt oxidation treatment salt recovery system according to yet another aspect of the present invention.

FIG. 10B is a schematic cross-sectional view of a molten salt oxidation treatment salt recovery system according to another exemplary embodiment of the invention.

FIG. 10C is a schematic of another molten salt oxidation treatment salt recovery system according to yet another exemplary embodiment of the invention.

FIG. 11 is a schematic of a molten salt oxidation reactor in accordance with an exemplary embodiment of the invention.

### DETAILED DESCRIPTION OF THE INVENTION

Molten salt treatment systems according to the invention may be used inter alia as Molten Salt Oxidation (MSO) reactors. MSO technology is a thermal process that is capable of destroying the organic constituents of mixed wastes, hazardous wastes, and energetic materials while retaining inorganic constituents in the salt.

Molten salt oxidation is a flameless thermal process which can be described as adding a liquid or solid feed with an excess of air or oxygen-containing gas into a molten salt bath containing a salt or mixture of salts, such as sodium carbonate (Na₂CO₃) and sodium chloride (NaCl), where the organic material is oxidized in the molten salt into primarily carbon dioxide and water. Typically, the waste stream is introduced below the liquid level of molten salt, but it may be introduced above the surface. The selection of salt for an MSO system is highly dependent on the type of feed to be treated; if the treatment of acid gases is desired, including a salt such as sodium carbonate in the system would be desirable so that acid components can be neutralized at the same time that organic constituents are oxidized. MSO reactors can be operated at various temperatures which are dependent on the salt composition. For example, MSO reactors with mixtures of sodium carbonate and sodium chloride might be operated in a temperature range of from above about 1500° F. to about 1800° F., as below about 1500° F., the molten salt may begin to solidify, or freeze. Thus, when starting up the MSO reactor or after cool down periods, the amount of heat required is increased above that of normal operation to melt the salt or remove the crust that forms on the surface of the salt. The non-volatile components accumulate in the molten salt solution where they can be collected and treated separately.

MSO technology has conventionally been used in small-scale operations and with limited use in industry. For example, the process has been used for coal gasification and destroying hazardous organics including polychlorinated biphenyls (PCB's), chlorinated solvents, wastes containing both organic and radioactive materials, and energetic (explosive) materials. The reactors used for such applications are typically quite small, often less than about six inches (0.15 m) in diameter. The configurations of such reactors are typically such that serious operability problems result if they are scaled up. The inventors have now found that MSO reactors can be configured for much higher volume operation, suitable for industrial scale processes.

One suitable process is waste disposal from the processes used to make the artificial sweetener sucralose. During the process to manufacture sucralose, a number of by-products are generated and end up in wastewater streams requiring treatment. One of the primary by-products that ends up in wastewater streams is inorganic salt in the form of sodium chloride. Other by-products that end up in these streams include chlorinated carbohydrates. These, along with inorganic and organic salts, prove to be difficult to treat with conventional waste treatment techniques, the most common of which are biologically-based treatment systems. In addition, biological systems can be very expensive to build and operate.

The present invention includes systems and processes in which the MSO technology is adapted to effectively treat inorganic and organic waste materials, for example, by-products from manufacturing sucralose. One such modification is the use of a molten salt reactor having considerably greater capacity than previously known MSO reactors. For example, the MSO reactor vessel may have an internal diameter of at least six inches (0.15 m), one foot (0.3 m), three feet (1 m), six feet (2 m) or even at least 12 feet (4 m). It may have a height of at least three feet (1 m), six feet (2 m), 18 feet (6 m), 36 feet (12 m) or even exceeding 75 feet (25 m). The attendant waste material delivery, air or oxygen feed, spent salt recovery and off-gas treatment thus also must be modified to meet the demands of such a system and process. However, the MSO technology provides a number of benefits for treating sucralose by-products. For example, it is expected that the capital required to build the treatment system would be approximately one-third that of a conventional waste treatment system. Further, the salt present in the by-product waste stream can be recovered and potentially converted back into the basic process raw materials of chlorine and caustic, such as sodium hydroxide. Conversion of carbon in the organic portions of the waste to carbon dioxide is typically high, about 90-99+%, if desired.

It should be noted that if the waste is part of a mixture that also contains valuable materials that are not destroyed by the oxidation process, for example valuable metals, the systems and methods of the invention may facilitate recovery of such materials. More generally, although typically referred to herein as oxidation systems, the devices and methods of this invention may be used for all applications in which high temperature processing is needed, including but not limited to oxidation. For simplicity the system will be described with respect to molten salt oxidation for waste treatment, but it is to be understood that use of the system is not limited to oxidation processes or to waste treatment processes and that other materials may be processed. For example, it is contemplated that the systems and methods of this invention may be useful in coal gasification processes and other processes requiring high-temperature treatment of fuels or fuel precursors.

The invention is best understood from the following detailed description when read in connection with the accompanying drawing, which shows exemplary embodiments of the invention selected for illustrative purposes. The invention will be illustrated with reference to the Figures, which are not drawn to scale and are not intended as engineering drawings. Such Figures are intended to be illustrative rather than limiting and are included herewith to facilitate the explanation of the present invention.

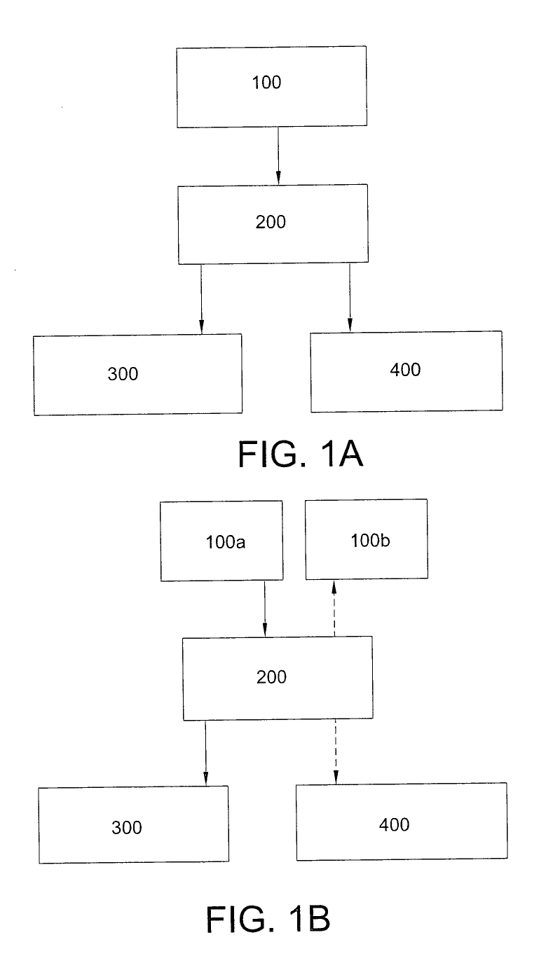

In one embodiment, the invention provides an MSO treatment system such as shown in FIGS. 1A and 1B. The system generally provides a feed system 100 (or 100a, 100b) flowably connected to a MSO reactor 200. The MSO reactor 200 is further flowably connected to an off-gas recovery system 300 and a spent salt recovery system 400. Optionally, the MSO treatment system may further be connected to remove molten salt from the MSO reactor 200 by salt removal system 100b in addition to or in place of molten salt recovery system 400. In other words, the present invention may optionally provide molten salt recovery via molten salt recovery system 400, in addition to or instead of salt removal system 100b. Each of the above-identified aspects of the present invention will be discussed in more detail below.

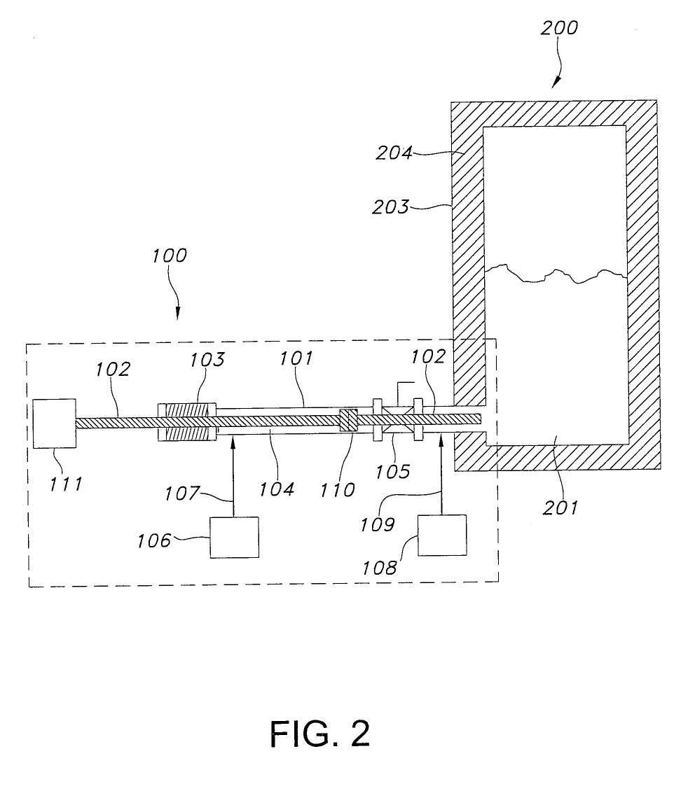

As shown in FIG. 2, the feed system 100 (or 100a, 100b) includes one or more tubular conduits 101 flowably connected to a MSO reactor 200. The MSO reactor can be constructed as a refractory-lined steel vessel or reactor, having an outer shell 203 and refractory 204. The reactor shell may be constructed from a variety of materials such as duplex stainless steels, austenitic stainless steels, superaustenitic stainless steels, high nickel austenitic stainless steels, or nickel based alloys. The molten salt contained within the MSO reactor includes a salt or a mixture of salts, such as sodium carbonate (Na₂CO₃) and/or sodium chloride (NaCl).

As shown in FIG. 2, the one or more tubular conduits 101 may be connected to a side of the molten salt reactor 200, with the tubular conduit 101 extending transversely with respect to the vertical axis of the reactor 200.

Each of the tubular conduits 101 contains concentrically within it a pipe or a shaft 102, separated from it by an annular space 104. The feed system 100 further includes one or more gas sources 106 and/or 108 connected to feed a gas, such as air, oxygen or nitrogen, into each of the tubular conduits 101. The gas may also include other oxygen containing gases that are suitable for supporting combustion in the MSO reactor 200. The gas may be supplied at a pressure of about 10 to about 100 psig when waste is fed to the MSO reactor 200. In an embodiment of the invention, the one or more gas sources 106/108 feed a gas into at least one tubular conduit 101 at a pressure sufficient to prevent backflow of molten salt into said tubular conduit 101. The gases being fed also serve to provide cooling to tubular conduit 101 and pipe or shaft 102. The cooling action of the gas allows the use of less expensive construction materials and extends the life of the components. When feeding gas or waste or performing feed system maintenance, positive gas flow is maintained to keep the port open. Pressure and flow sensors (not shown) may be included and are designed to monitor all critical flows and pressures.

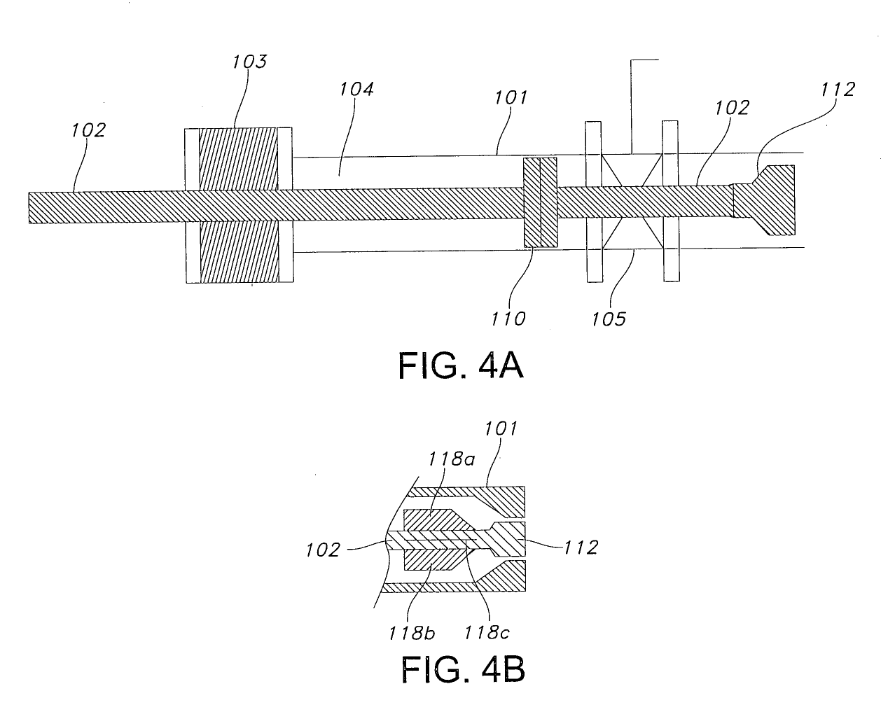

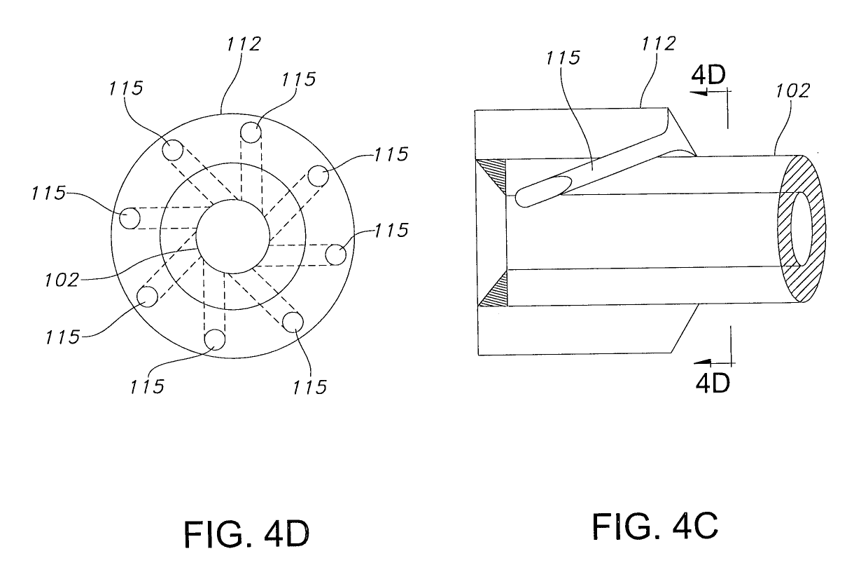

As shown in FIG. 2, the one or more tubular conduits 101 are optionally connected to the MSO reactor 200 at a location below, or subsurface, of a liquid level of molten salt 201 in the molten salt oxidation reactor 200, for example to a side of the molten salt reactor 200, with the tubular conduit 101 extending transversely with respect to the vertical axis of the reactor 200. The salt may be kept molten by any known means, such as an electric arc heater embedded in the salt or by use of a is natural gas burner. The feed system shown in the embodiment of FIG. 2 includes an airlock chamber in a portion of the one or more tubular conduits 101. In FIG. 2, the airlock chamber is formed within conduit 101 between a sealing device 103 at an upstream location of the one or more tubular conduits 101 and a corresponding sealing device such as valve 105 having open and closed positions at a downstream location of the one or more tubular conduits 101. The term “upstream” as used herein means the relative location closest to the origin of flow and the term “downstream” being the relative location farthest from the origin of flow. Gas feed source 106 provides gas via pipe 107 to maintain the pressure of the airlock chamber. Gas is fed to the system from feed source 108 via pipe 109. The pressure at which the airlock chamber is maintained depends upon where the conduit is connected to the reactor and what process configuration has been set up for each particular conduit assembly. For example, if feed system 100 is being used to feed a liquid waste subsurface using the feed device depicted in FIGS. 4A-D, the airlock pressure may preferably be maintained at a pressure of about 65 psig. An exemplary sealing device 103 suitable for use in the present invention is a packing gland, which can be made from high temperature packing. The valve 105 must be able to allow the pipe or shaft to penetrate, or pass through. One example of such a valve is a full port ball valve.

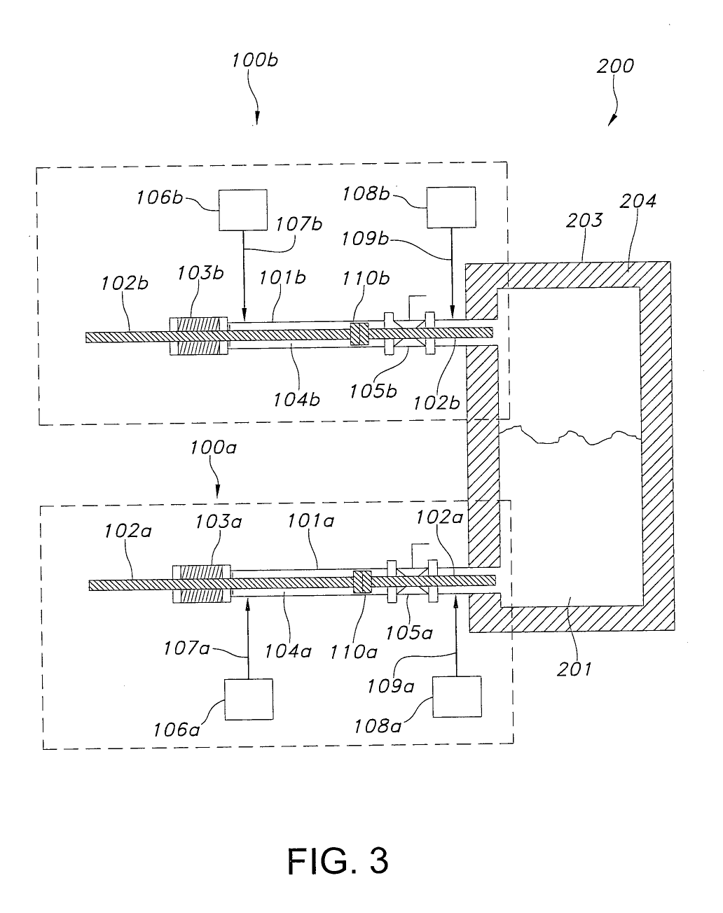

In another embodiment, shown in FIG. 3, liquid or solid waste is fed through one of the tubular conduits 101a, with air pressure behind it to help prevent salt backflow and to help disperse the liquid waste. Simultaneously, air may be fed into the other tubular conduit or conduits 101b to provide enough air to achieve the desired oxidation level. The pressure maintained in the airlock chamber for those conduits feeding only air or other gas, i.e., without feeding waste, may be maintained in a range of from about 15 to about 20 psig.

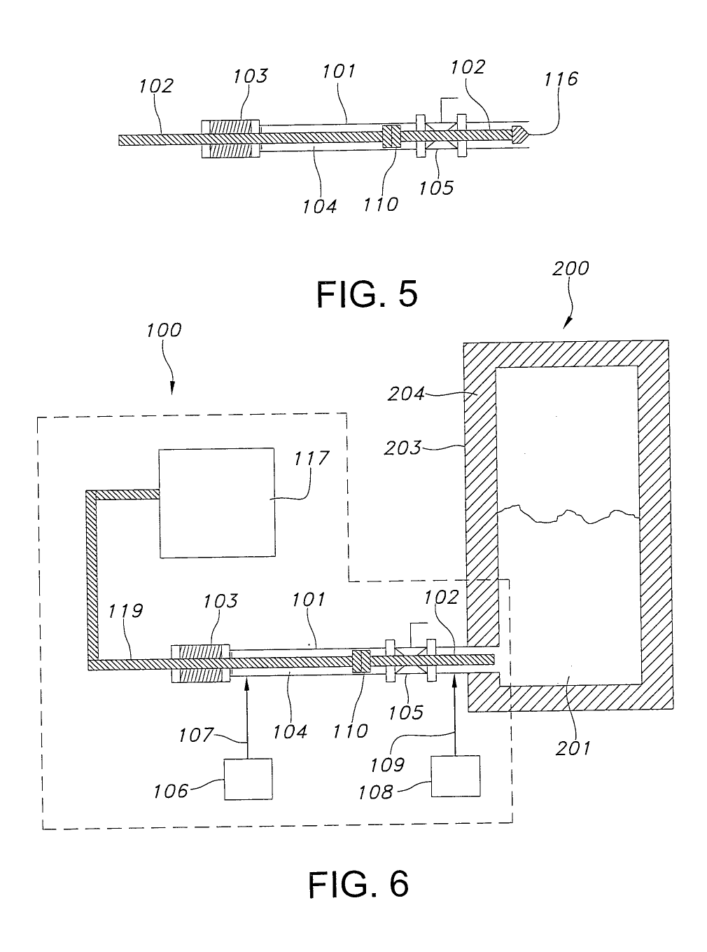

When the shaft or pipe 102 or their attachments are changed, the procedure includes loosening the sealing device 103 and retracting the pipe or shaft 102 until it is completely removed to the upstream end of the valve 105. Next, the valve 105 is closed, at which point the air lock chamber can be disassembled and re-configured, if desired. In an embodiment of the present invention, a screw type valve arrangement can be mounted external to, or upstream of, the sealing device 103, so that a solid shaft 102 with a tapered end piece mounted on the downstream end can be gradually and variably inserted and retracted into an injection pipe seat. An example of such a configuration is depicted in FIG. 5, in which the tapered end piece is labeled as component 116. The screw type arrangement can be manually adjustable or it can be automated. This equipment assembly is used for the purpose of air flow control when feeding waste through a different conduit assembly. This same assembly can also be used in the fully inserted position to minimize air flow into salt bath while keeping the passageway into the molten salt open. This is desirable because excess air fed into the reactor acts as a heat drain on the system and can affect the desired chemistry in the reactor. In other words, the gas composition leaving the reactor can be dramatically affected by the amount of air being fed into the MSO reactor.

Optionally, the feed system of the present invention can include a stop limit 110 attached to, or integral with, shaft or pipe 102. The stop limit 110 serves as a safety device keeping the pipe or shaft 102 from being pushed or pulled out of the MSO reactor 200 and the air lock chamber created between sealing device 103 and valve 105. An exemplary stop limit that may be used in the present invention is a pipe flange or coupling on shaft or pipe 102, provided that it is not so large as to block gas flow through tubular conduit 101. Other devices to achieve the purpose of the stop limit may also be used, such as a stud or other projection extending laterally from shaft or pipe 102. The position of the stop limit 110 on pipe or shaft 102 should be set so that there is enough distance or length available between sealing device 103 and valve 105 to fully retract the downstream end of pipe or shaft 102 past valve 105.

In some embodiments of the present invention such as shown in FIGS. 2, 3 and 4A, the feed device 100 includes a pipe 102. The pipe is connected to a feed source 111 to feed a material to the MSO reactor 200. The feed may be continuous or batch-wise, including intermittent. The feed source 111 optionally includes an evaporating device flowably connected to the one or more tubular conduits 101 upstream of the one or more tubular conduits 101. This allows for the removal of solvent, such as water, from the feed stream to minimize or prevent the overpressurization of the MSO reactor 200 as the feed stream is introduced into it. For example, if the solvent is water and the water content is too high, an explosion could occur when injecting the feed stream into the molten salt bath. It is also desirable to remove solvent prior to feeding the MSO reactor to limit the heat drain from the salt bath. Removal of solvents prior to the MSO reactor also allows for the recovery and re-use of those solvents. The waste stream fed to the MSO reactor 200 preferably should be sufficiently Towable but have a reduced solvent content. Streams with higher solvent content, however can be fed to the unit but at a reduced flowrate to allow for additional gas load generated in the MSO reactor, to reduce the risk of explosion. Optionally, as discussed above, the pipe 102 can be designed to feed nitrogen, air, or some other oxygen-containing gas into the MSO reactor 200.

The material fed to the reactor may include a number of waste products from a variety of sources. The MSO treatment process is of particular use in treating halogenated waste material, and more specifically, for example, chlorinated carbohydrates or other chlorinated organic waste material, as well as sodium acetate and other organic salts that are by-products from a sucralose manufacturing process. In an embodiment of the invention, the feed stream may comprise a viscous waste stream having about 75% to about 80% or more solids. Where the feed material is waste from a sucralose manufacturing process, the feed material will typically be maintained at a temperature of about 160° F. to about 190° F. to prevent the feed material from solidifying and plugging the feed line. Optionally, solid wastes can be added to the MSO reactor system, although the feed systems would need to be modified accordingly. For example, simple sealed auger type devices might be employed for this purpose.

Alternatively, the feed material may include an intermediate material from which a high value salt or other non-volatile inorganic component, such as a metal, may be recovered rather than lost as a waste material.

In an embodiment in which the feed system 100 includes a pipe 102 connected to feed a stream of material to the MSO reactor 200, the feed system may comprise a feed gun with an atomizing feed nozzle 112 such as that shown in FIG. 4A. The nozzle 112 is applied to the downstream end of the pipe 102. The nozzle 112, according to the embodiment shown in FIG. 4A, is welded in the form of a collar onto the end of pipe 102. As shown in more detail in FIG. 4B, the nozzle 112 is optionally fitted with at least one fin, illustrated in FIG. 4B as fins 118a, 118b and 118c, that are included for centering the feed nozzle 112 in the tubular conduit 101, and for preventing the accidental extraction of pipe 102 from conduit 101.

The nozzle 112, as shown in more detail in side cross-sectional view of FIG. 4C and end cross-sectional view of FIG. 4D, along lines 4D-4D, includes multiple passages 115 as shown. The view in FIG. 4D is of the upstream end of the nozzle 112. Eight passages are shown, but in general two or more should be used. For simplicity, only one passage 115 is shown in FIG. 4C. As shown, the passages 115 pass from the upstream end of nozzle 112 into the interior of pipe 102, terminating near its downstream end, so that the liquid waste exiting them is atomized. In some embodiments, such as that shown in FIG. 4D, the passages are oriented to conduct air passing through them in an inwardly twisting direction. This shears and imparts a swirling motion to the waste exiting pipe 102.

When fully inserted, the atomizing nozzle 112 is centered inside the combustion air passage, that is, the annular space 104 between the tubular conduit 101 and the pipe 102. As shown in FIG. 4B, the downstream end of tubular conduit 101 may be tapered inwardly to restrict the size of the air passageway. The diameter of the atomizing nozzle is set to minimize the annular space between the nozzle 112 and conduit 101. This forces the air or gas being delivered from sources 106/108 to flow primarily through the atomizing passages 115. The resultant narrowed annular space between nozzle 112 and conduit 101 provides a high velocity hollow cylindrical stream of combustion air for the feed material while at the same time providing a high pressure drop, for example a 65 psig pressure drop, from the upstream end of the nozzle 112 to the downstream end of the nozzle 112. This high differential is used to force air through the atomizing passages 115. The swirling action imparted by the air exiting the passages maximizes mixing of the feed stream with the combustion air as the feed stream enters the molten salt bath 201 of the MSO reactor 200. It has been determined that such an atomizing nozzle configuration provides a significant reduction in the amount of combustion air required to keep carbon monoxide (CO) production sufficiently low.

In an alternative embodiment of the present invention, the pipe or shaft is a shaft 102, for example, as shown in FIG. 5. The shaft 102 may comprise a drill bit, which is represented by reference numeral 116, mounted onto a downstream end of said shaft 102. Drill bits contemplated for use in the present invention may be of any suitable configuration capable of drilling into molten salt in the MSO reactor 200 that has cooled and solidified. For example, the drill bit may be diamond-tipped. The shaft 102 mounted with drill bit 116 is capable of boring into the salt bath 201 until a path into the molten area is reached. When operated according to this embodiment, the system maintains a minimum velocity of gas at all times to prevent back flow of molten salt once the path is clear. It is also contemplated that the shaft 102 may comprise other maintenance equipment mounted onto the shaft 102.

In yet another embodiment according to this aspect, the present invention includes a feed gun that includes a feed nozzle 112 mounted on pipe 102. The feed gun is preferably removable. The feed gun can be removed and inserted, for example, with the use of a flexible hose that is attached to the upstream end of the feed gun. Preferably, the flexible hose is electrically traced to maintain sufficiently high temperatures to prevent the liquid waste from cooling and solidifying. The feed gun in such an embodiment is designed to remain outside of the feed system 100 when not in use. The feed nozzle 112 can be installed by removing the plugged shaft 102 and quickly inserting the feed nozzle 112 into tubular conduit 101 and reconnecting to establish flow.

Optionally, as shown in FIG. 3, in which more than one tubular conduit 101a and 101b is used, the invention can include at least one tubular conduit 101a containing a pipe, for example 102a, and at least another of the tubular conduits 101b containing a shaft 102b.

In yet another embodiment according to this aspect, a feed system such as shown in FIGS. 2, 3, 4A, and 6 may be used instead as a molten salt discharge system in which one or more pipes 102 removes molten salt 201 from the MSO reactor 200. In such an embodiment, the pipe 102 is a drain pipe that may be inserted into tubular conduit 101 or connected to pipe 102, in which the pipe 102 further is connected to pipe 119 to connect pipe 102 to a salt recovery vessel 117. This could be performed by reducing the gas supply from gas sources 106 and/or 108 or by shutting off such gas supply. The pipe 119 between sealing device 103 and salt recovery vessel 117 is preferably a long electrically traced flex hose, optionally supported in a steel trough.

In an exemplary embodiment, the present invention can include tubular conduit 101 with a pipe 102 concentrically contained within it. The pipe 102 is connected to receive molten salt 201 discharged from MSO reactor 200 to discharge the molten salt to a salt recovery vessel 117, when the gas flow to the MSO reactor 200, via the tubular conduit 101, is decreased or shut off. The tubular conduit 101 may be connected to a side of the molten salt reactor 200, with the tubular conduit 101 extending transversely with respect to the vertical axis of the reactor 200. The salt recovery vessel 117 may be, for example, an open hole or pit in which the molten salt is allowed to cool and solidify in preparation for re-processing back to the MSO reactor 200 or disposal. Alternatively, the salt recovery vessel 117 can include a salt dissolution vessel in which the salt is collected and dissolved in a solvent, such as water. Preferably, this embodiment for salt removal is utilized when the system is operated in batch mode, however, it is contemplated that such operation may also be utilized when the system is operated continuously. Optionally, one or more additional tubular conduits 101 are also included, wherein each of the tubular conduits includes a pipe 102 for feeding material or for removing waste and/or a shaft 102.

Generally, operation of the MSO reactor should be maintained to achieve an optimum air or oxygen to waste ratio. The ratio itself is dependent on the waste to be processed. Determining the optimum ratio may be done by conducting experiments with the actual feed to be treated (either at pilot plant or full scale). With the system fully operational, reactor off-gas samples can be pulled and analyzed at different oxygen to waste ratios; the off gas might be analyzed for concentrations of carbon monoxide, nitrogen oxides, methane, and potentially other compounds. The results of these tests can then be used to determine which oxygen to waste ratio performs best. The number of feed systems required is dependent on the total flow targets desired and the requisite ratio. It is also believed that feeding air at several different points serves to help agitate or mix the molten salt bed. The mixing induced by the air and waste combustion is believed to help ensure uniform and consistent operation of the reactor.

In a preferred embodiment of the present invention, the MSO reactor system is designed to have at least 4 air/waste feed points running when the system is in operation. Preferably, the feeder systems are spread around the circumference of the reactor.

Related to the system described above, the invention, in another aspect, includes a process for treating waste in a molten salt oxidation reactor system. The process comprises the steps of delivering liquid material via a pipe concentrically contained within a tubular conduit connected to the molten salt oxidation reactor and injecting a gas, such as air, into the tubular conduit. The gas has a pressure sufficient to prevent molten salt from backflowing out of the molten salt oxidation reactor into the tubular conduit or the pipe.

Optionally, the process includes the step of removing a solvent, for example water, from the liquid material in an amount sufficient to prevent overpressurization when the liquid material is introduced into the molten salt oxidation reactor under operating conditions. In an embodiment according to this aspect, where the solvent is water, it is removed by evaporating the water from the liquid material.

Further optional steps that may be included in embodiments of this aspect include heating the liquid material prior to delivering the liquid material to the molten salt oxidation reactor and maintaining an airlock in a portion of the tubular conduit.

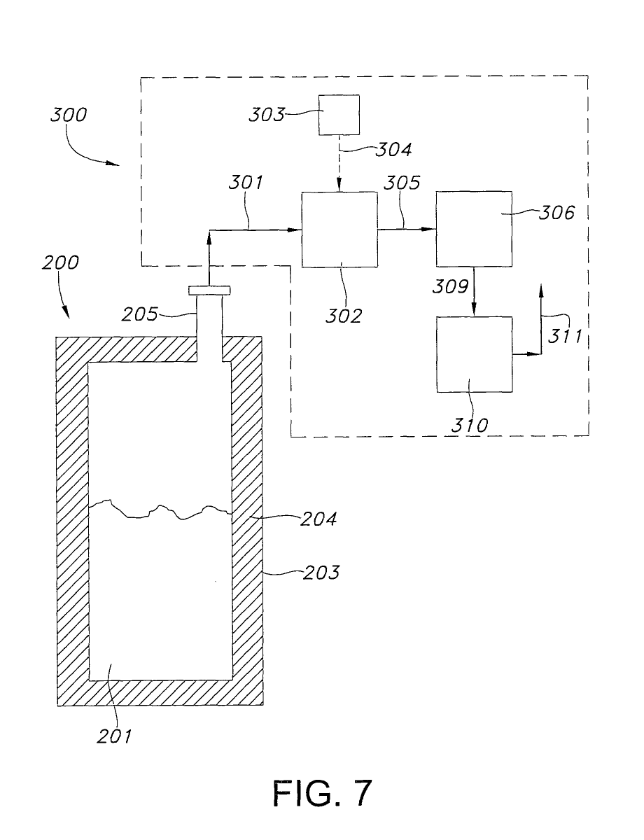

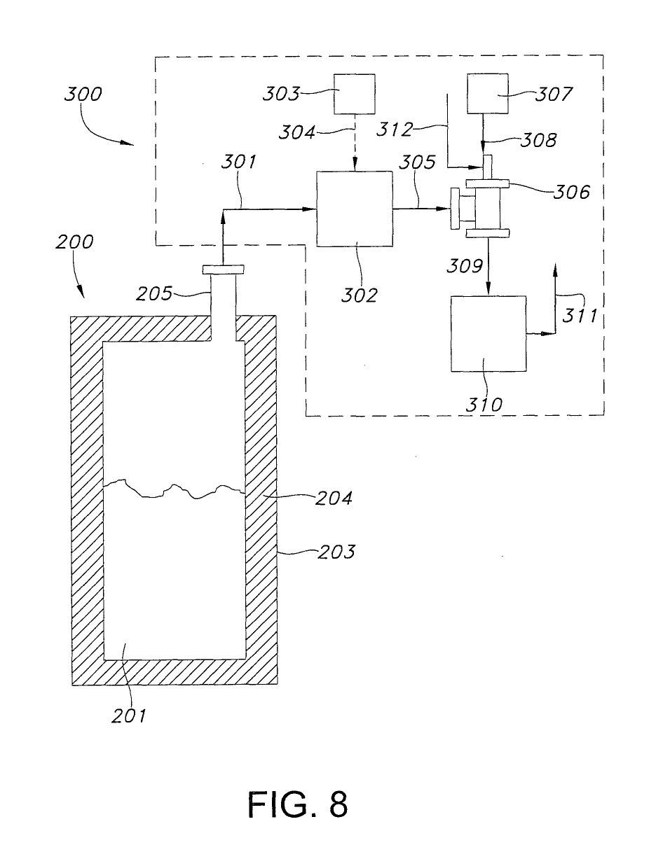

In another aspect, the present invention provides a molten salt oxidation treatment system, such as that shown in FIG. 7, which includes an off-gas recovery system 300. In an embodiment according to this aspect, the system includes a scrubbing device 302 flowably connected to an off-gas outlet 205 of an MSO reactor 200 to receive an off-gas containing entrained solid particulate material, such as salt, from the MSO reactor 200. As shown in FIG. 7 and FIG. 8, the off-gas outlet 205 may be connected to the top of the molten salt reactor 200, with the off-gas outlet 205 extending longitudinally with respect to the vertical axis of the reactor 200. Further, the invention provides a heating device 306 configured to heat the gaseous effluent from the scrubbing device 302 and a filtering device 310 flowably connected to receive the gaseous effluent from the heating device 306.

As shown in FIG. 7, the off-gas containing entrained salt from the MSO reactor 200 is discharged from off-gas outlet 205 and is fed to the scrubbing device 302 via pipe 301. The scrubbing device provides quench cooling and gross removal of entrained solid particulate material, such as salt, from the off-gas. Water, or another cooling liquid, is fed to the scrubbing device from liquid source 303 via pipe 304. In an exemplary embodiment, the liquid source may supply water recycled from other processes or fresh water provided from a fresh water source. Exemplary scrubbing devices include water scrubbers and venturi scrubbers for removal of entrained solid particulate in an amount expected to be in the range of about 90% or more, more preferably, in an amount of about 90 to about 99%, and most preferably in an amount >99%.

Alternatively, it is also contemplated that a suitable off-gas treatment system might include an electrostatic precipitator used alone or in conjunction with a venturi water scrubber, positioned either upstream or downstream of the electrostatic precipitator. A venturi scrubber accelerates the off-gas stream to atomize the scrubbing liquid, such as water, to improve gas-liquid contact. It is also contemplated that other types of water scrubbers could also be used with or in place of the venturi scrubber and electrostatic precipitator. The operation and design of such scrubbers is known to one of ordinary skill in the art.

The gaseous effluent from the scrubbing device 302, for example a water saturated gas stream with some residual salt, must be suitable for discharge to the atmosphere or some other off gas handling system. The inventors have found that direct discharge to the atmosphere is sometimes not possible, due to opacity concerns around the exhaust stack, without further treatment of this gas stream. To produce a gas stream suitable for discharge, a system may be used to first heat the water saturated gas stream such that it was no longer saturated and then to filter the stream prior to discharging to the atmosphere.

Referring to FIG. 7, the gaseous effluent from the scrubbing device 302, for example a water saturated gas stream with some residual salt, is fed to heating device 306 via pipe 305 for heating the gaseous effluent. Heating devices suitable for use in heating the effluent from the scrubbing device may include a direct-heating device, such as a gas burner. As shown in FIG. 8, in which the heating device 306 is shown as a natural gas burner, the heating device 306 includes a gas source 307 for feeding gas to the gas burner via pipe 308 and air via inlet 312. In such a direct heating device, the gaseous effluent is superheated, for example, from a temperature of about 170° F. to about 230° F., by being directly contacted with the combustion gases from the burner. Alternatively, the heating device 306 may include an indirect heating device, such as a heat exchanger, in which the gaseous effluent is heated by, for example, by heat transfer through the walls of the heating device that separate the heating medium from the gaseous effluent. Heating increases the temperature of the gas stream above its saturation point and allows for the gas to be passed through a fine filter to remove any remaining salt particulate. Preferably, the heating device 306 heats the gaseous effluent to a temperature above the saturation temperature of the gaseous effluent.

The heated gaseous effluent is next fed to a filtering device 310 via pipe 309. One example of a suitable filtering device includes a baghouse, which is preferably insulated, although other filtering devices, such as electrostatic precipitators, may also be used. The filtered gaseous effluent can then be vented, optionally to the atmosphere via pipe 311, or alternatively, recovered and reused in further processes via pipe 311, for example. Operation of the off-gas treatment system may be ultimately designed to meet or exceed chemical content and opacity requirements.

In yet another aspect related to the above-described system, the invention provides a process for treating off-gas from a molten salt oxidation reactor system comprising the steps of scrubbing an off-gas containing solid particulate matter discharged from the molten salt oxidation reactor to produce a moisture-containing gaseous effluent, heating the moisture-containing gaseous effluent, for example above its dew point, and filtering the effluent to remove entrained solid particulate matter. In an embodiment according to this aspect, the solid particulate matter is salt.

In the scrubbing step, the scrubbing may be performed using a water scrubber, a venturi scrubber, or the like, the details of which have been described previously.

In the step of heating the moisture-containing gas, the process may further include the step of heating a water-saturated gaseous effluent to a temperature above a saturation temperature of the effluent.

The process may also include the optional step of venting the gaseous effluent to atmosphere after filtering in the filtering step.

It is also contemplated, as an optional embodiment, that a wet electrostatic precipitator could be employed with or without a traditional water scrubber to affect the gross salt removal step.

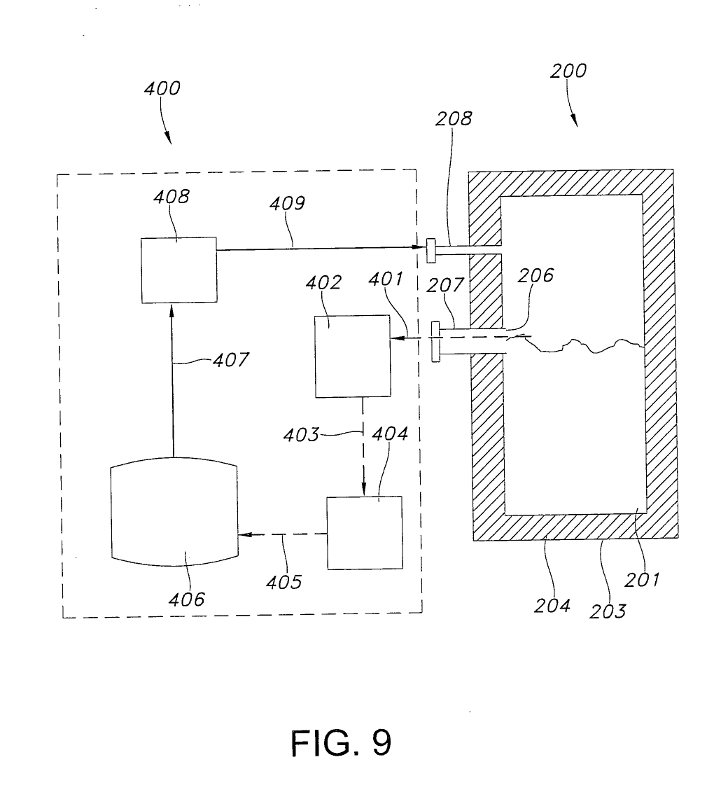

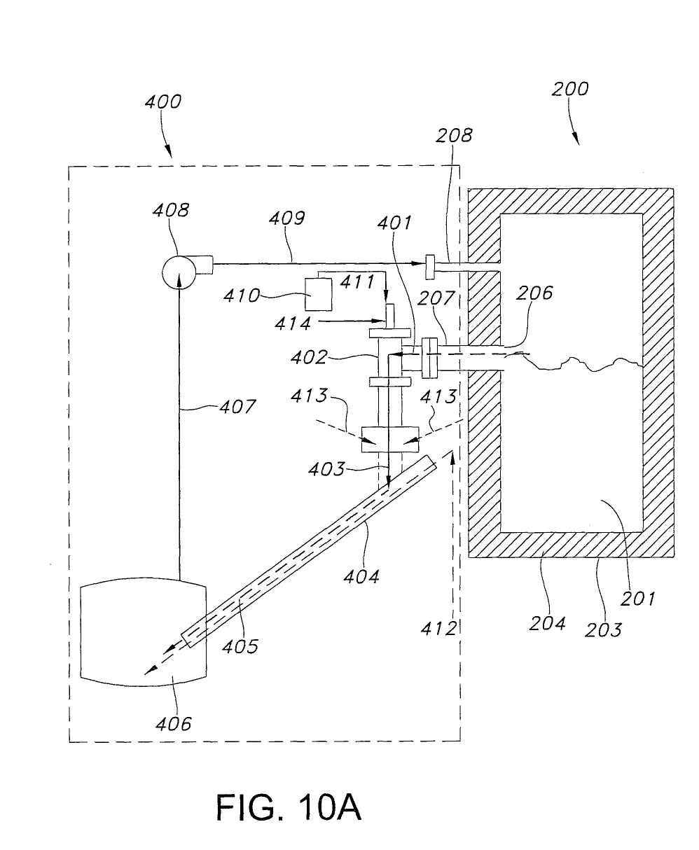

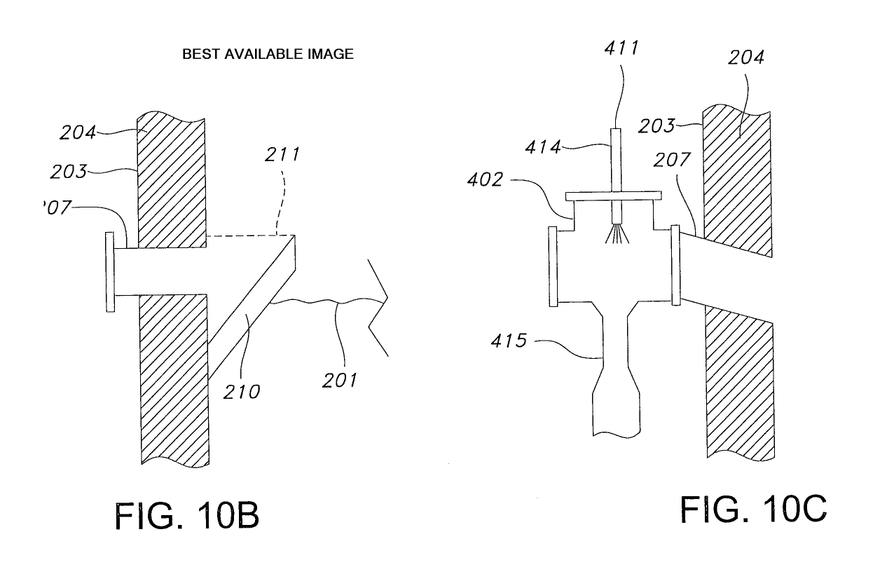

In yet another aspect, the invention provides a molten salt oxidation treatment system in which the molten salt can be removed from the MSO reactor 200 as it accumulates. Of particular advantage when operating the MSO reactor 200 continuously, the system includes an embodiment of the invention, such as shown in FIG. 9, including a molten salt recovery system 400. As shown in FIG. 9, the system includes an overflow conduit 401 flowably connected to a MSO reactor overflow outlet 207 to receive molten salt from the overflow outlet 207 and discharge the molten salt to a salt recovery vessel 406. As shown in FIG. 9 and FIG. 10A, the overflow conduit 401 may be connected to the side of the molten salt reactor 200, with the overflow conduit 401 extending transversely with respect to the vertical axis of the reactor 200. The overflow conduit 401 is preferably insulated to prevent the molten salt from cooling and solidifying in the conduit. The molten salt is discharged from the MSO reactor 200 via the overflow outlet 207 when the molten salt 201 reaches the molten salt overflow point 206. The system further includes a blower 408 connected to the MSO reactor 200, via line 409 and gas inlet 208, and the salt recovery vessel 406 and configured to generate conditions sufficient to maintain uni-directional flow of gases out of the MSO reactor 200 to prevent backflow of cold gases to reactor. Such backflow of cold gases would cause salt to freeze at the overflow conduit. Any gas substantially colder than the molten salt is a “cold gas.” For example, even steam, unless it is sufficiently superheated, may freeze the molten salt. The blower 408 helps prevent plugging in the overflow system by acting as a gas mover to maintain uni-directional flow from MSO reactor 200 all the way to the salt recovery vessel 406. The blower 408 forces hot gas flow out of the MSO reactor 200 in the direction of the salt recovery vessel 406. As will be discussed further below regarding FIG. 10A, another type of gas mover may comprise superheated steam injectors to assist in maintaining uni-directional flow.

Optionally, an embodiment of the system further includes a heating device 402 connected to introduce hot gas into the overflow conduit. As shown in FIG. 9, the molten salt from overflow conduit 401 is heated by heating device 402 to heat, or at least maintain the temperature of, the molten salt as it is transported away from the MSO reactor 200. Exemplary heating devices suitable for use in this capacity include a direct heating device, such as a natural gas burner, and an indirect heating device, such as a heat exchanger or heat tracing. FIG. 10A includes an embodiment showing the heating device 402 as a gas burner having a gas source 410 for feeding gas to the heating device 402, via pipes 411, and air via inlet 414.

The molten salt is optionally fed, via pipe 403, to salt dissolution device 404, as shown in FIG. 9. The salt dissolution device 404 cools and dissolves the salt in water to form an aqueous salt solution. The aqueous salt solution is transported from the salt dissolution device 404 via pipe 405 to a salt recovery vessel 406. In a preferred embodiment, such as shown in FIG. 10A, the salt dissolution device 404 comprises a sluice line. In this embodiment, water from water feed 412 and molten salt from the reactor are fed simultaneously into the sluice line 404. In this embodiment, pipe 405 is integral with (or an extension of) the sluice line 404, and carries the resulting salt solution to salt recovery vessel 406. The water is fed to dissolve the molten salt within it to form a solution or slurry of salt in water. The water is fed in amounts sufficient to minimize temperature rise, and therefore vapor pressure, of the water.

The flowing water in the sluice line cools the molten salt by providing enough water to dissolve the molten salt and keep the temperature cool enough to reduce or prevent excessive steam formation that can back up into the salt overflow outlet far enough to cause salt freezing and plugging in recovery system lines (e.g., 401 and 403). In other words, the system controls the differential pressure of the gas between the salt reactor and quench tank so that there is no backflow of water vapor into the salt overflow outlet. Otherwise, if the salt overflow line does not remain hot and dry from the MSO reactor to the water contact point, the backflow of steam vapors can cause the salt to freeze and plug the line.

The system is designed to remove molten salt from the MSO reactor 200, in which the molten salt stream typically has temperatures of 1500° F. or higher into a water bath near 212° F. without freezing the salt too quickly.

Also as shown in FIG. 10A, an exemplary gas mover can include a blower 408 having a low pressure side flowably connected via pipe 407 to a salt recovery vessel 406 (for example, a dissolution vessel), and a high pressure side flowably connected via pipe 409 to the molten salt oxidation reactor 200.

Optionally, the system may also further include one or more directional superheated steam injectors 413 configured to impinge and break up a stream of molten salt issuing from said overflow conduit 401 and to direct the molten salt to the salt recovery vessel 406. These steam injectors also act as gas movers because they prevent backflow of cold gases to the reactor 200.

Through the use of the blower 408, and further supplementing the blower 408 with the optional heating device 402, optional salt dissolution device 404 and the optional directional steam injectors 413, the gas flow from the MSO reactor 200 is maintained in a uni-directional flow to the salt recovery vessel 406. For example, in one embodiment, by using the blower 408 to generate a lower pressure in the salt recovery vessel 406, heating the molten salt with a gas fired burner 402, preferably providing directional gas flow downward via directional steam injectors 413 above a sluice line 404, and using a high flow of coolant/dissolution water 412 in the sluice line 404 to minimize steam formation, the hot gas is forced out of the MSO reactor 200. This prevents the salt from freezing in the lines of the molten salt overflow recovery system and plugging them. Such operation generates temperature and pressure conditions sufficient to prevent backflow of cool gases to the molten salt oxidation reactor.

Additionally, it is contemplated that the salt dissolution device 404, such as the sluice line depicted in FIG. 10A, may also be used in conjunction with the underflow molten salt recovery via pipe 102, as shown in FIG. 6. In such an exemplary embodiment, the invention may comprise electrical resistance heating whereby an electrical current is passed through the conductive molten salt, heating the molten salt and allowing the molten salt to remain molten. This would involve setting up a flow channel with two metallic pieces connected to a positive and a negative electrical grid to utilize the electric arc heating in the salt removal lines to heat the salt and prevent the molten salt from cooling and thus solidifying or freezing. An exemplary embodiment could involve setting up a flow channel with two metallic pieces connected to a positive and negative electrical grid. Such heating devices are known to those of ordinary skill in the art.

In another exemplary embodiment for removing molten salt from the MSO reactor the MSO reactor includes a salt overflow splash shield, such as a weir, inside the reactor positioned at the overflow outlet 207 of the reactor. As is shown in FIG. 10B, the splash shield 210 is designed to prevent splashing from the turbulent liquid surface up against the overflow outlet 207. The splash shield is included to prevent slugs of molten salt from entering the salt recovery system 400. The splash shield 210 is shown in FIG. 10B as an internal overflow weir. As shown in FIG. 10B, the shield 210 is positioned a predetermined height 211 just above the top of the overflow outlet 207. The splash shield 210 is preferably made from a refractory coated steel material. In a preferred embodiment, the base of the shield is located a predetermined height, for example 6-12 inches, below the bottom of the overflow outlet 207. It is believed that the molten salt will build up and run around the splash shield 210 and flow out of the overflow outlet 207.

In yet another exemplary embodiment for removing molten salt from the MSO reactor, the MSO reactor optionally includes a sloping overflow outlet 207, as shown in FIG. 10C, and an optional restriction neck 415 in the line exiting the heating device 402. Also, by limiting flow discharged from the salt overflow outlet 207 via the restriction neck 415 to the downstream portions of the spent salt recovery system 400, splashing of the salt in the reactor which causes slugs of molten salt to enter the salt recovery system 400 can be avoided. Further, the slope of the overflow outlet 207 may be angled back toward the molten salt oxidation reactor 200 to aid in reducing the effect of splashing of the molten salt in the reactor in producing slugs of flow in the salt recovery system 400.

Related to the system described above, in still yet another aspect, the present invention includes a process for discharging molten salt from a molten salt oxidation reactor. In an embodiment according to this aspect, the process includes heating or maintaining a temperature of a molten salt stream discharged from the molten salt oxidation reactor to a salt recovery vessel to maintain the molten salt stream in a molten state and generating a pressure sufficient to prevent backflow of cold gases to the molten salt oxidation reactor. In the process, the step of generating a pressure may comprise generating a low pressure in the dissolution recovery vessel and a high pressure in the molten salt oxidation reactor with a blower.

As a further step, the process may further include the step of cooling and dissolving the molten salt stream prior to introducing the molten stream to a salt recovery vessel, for example using water in a sluice line.

Another step of the process can optionally include the step of directing the molten salt overflow stream to the salt recovery vessel using one or more directional superheated steam injectors.

The process according to this aspect can also include recovering salt from the molten salt oxidation reactor in a salt solution or, alternatively, as a solid.

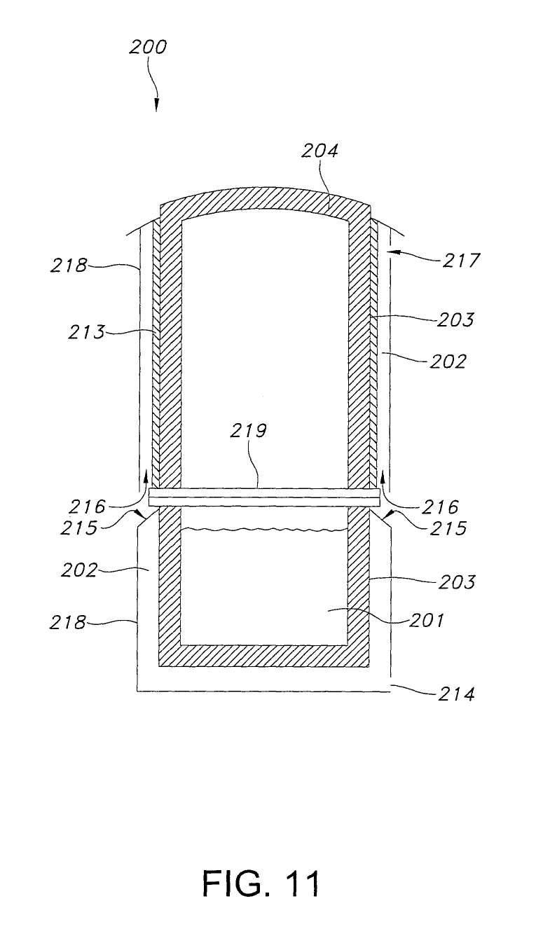

In yet another aspect, the invention includes an embodiment comprising an MSO reactor 200 that includes a ventilated annular space 202 around the reactor shell 203, which includes the bottom of the reactor, to prevent the shell 203 from overheating. FIG. 11 depicts a design that reduces thermal growth inconsistencies during changes in environmental conditions, such as a driving rain. For example, when one side of the unit is cooled by rain or wind more than the other side of the MSO reactor 200, uneven metal expansion of the shell 203 can occur. This can result in the shell 203 being ripped apart at its joints. In an embodiment of the invention, the MSO reactor may thus be equipped with a temperature shield, with an air gap 202 between the shell 203 and outer temperature shield 218, as shown in FIG. 11. When installed on the MSO reactor 200, the design allows the shell 203 to withstand temperature extremes by allowing the shell 203 to expand and contract evenly.

As shown in FIG. 11, the exemplary MSO reactor 200 includes refractory 204 and outer shell 203. In the exemplary embodiment illustrated, between the reactor shell 203 and outer temperature shield, 218, the MSO reactor 200 includes an annular space 202 with an air inlets 214 and 216 and air vents 215 and 217. The air introduced via air inlets 214 and 216 may be provided by an air blower (not shown). In the embodiment as shown in FIG. 11, the MSO reactor 200 may further include an insulation blanket 213 interposed between the reactor shell 203 and the outer temperature shield 218 on an upper portion of the MSO reactor, for example above the body flange 219 on the reactor 200, as shown.

It should be noted that materials of construction utilized in the systems according to the present invention are preferably steel or nickel based alloys due to the high temperatures and salt present in the system. Materials such as Inconel or Hastelloy are typically used if the material is to be in contact with high temperature salt streams or aqueous salt streams.

In still another embodiment of the present invention, the MSO reactor vapor space (i.e., the area above the molten salt) can be used for thermal oxidation treatment of combustible gases or vapors, e.g., vent gases from other processes. It is contemplated that using the MSO reactor in a dual purpose role can have a significant impact on a plant's energy consumption. For example, it could eliminate the need for a separate thermal oxidizer system for these vent gases. In addition, in such an embodiment the number of emission points from a facility that would have to be monitored could also be reduced.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A molten salt treatment system comprising:
a molten salt reactor comprising a vessel containing a molten salt;
one or more tubular conduits flowably connected to the molten salt reactor, each of said tubular conduits containing concentrically within it a corresponding pipe or shaft so as to form an annular space therebetween; and
one or more gas sources connected to feed a gas through the annular space in at least one of said tubular conduits into the reactor.

2. The system of claim 1 wherein said one or more tubular conduits is connected to the molten salt reactor at a location below a liquid level of molten salt in the molten salt reactor.

3. The system of claim 1 further comprising a first sealing device at an upstream location in at least one of said one or more tubular conduits, and a second sealing device in said at least one tubular conduit at a downstream location.

4. The system of claim 3 wherein said second sealing device is a valve having open and closed positions.

5. The system of claim 4 wherein said first sealing device comprises a packing gland.

6. The system of claim 1 wherein said pipe or shaft further comprises a stop limit.

7. The system of claim 6 wherein said stop limit comprises a coupling.

8. The system of claim 1 wherein in at least one of said one or more tubular conduits, said pipe or shaft is a pipe connected to a feed source to feed a material to the molten salt reactor.

9. The system of claim 8 wherein said material comprises halogenated waste material.

10. The system of claim 9 wherein said material comprises chlorinated waste material from a sucralose manufacturing process.

11. The system of claim 1 wherein said pipe or shaft is a shaft.

12. The system of claim 11 wherein said shaft comprises a drill bit mounted onto a downstream end of said pipe or shaft.

13. The system of claim 1 wherein at least one of the tubular conduits contains a pipe and at least one other tubular conduit contains a shaft.

14. The system of claim 1 wherein said gas comprises air.

15. The system of claim 1 further comprising an evaporating device flowably connected to said one or more tubular conduits upstream of said one or more tubular conduits.

16. The system of claim 1 wherein said pipe or shaft is a pipe connected to receive molten salt discharged from the molten salt reactor and to discharge the molten salt to a salt recovery vessel.

17. A molten salt treatment system comprising:
a molten salt reactor comprising a vessel capable of containing a molten salt, said vessel flowably attached to an off-gas outlet;
a scrubbing device flowably connected to the off-gas outlet to receive an off-gas containing entrained salt therefrom;
a heating device configured to heat the gaseous effluent from the scrubbing device; and
a filtering device flowably connected to receive said gaseous effluent from said heating device.

18. The system of claim 17 wherein said scrubbing device is a water scrubber.

19. The system of claim 17 wherein said scrubbing device comprises a venturi scrubber.

20. The system of claim 17 wherein said heating device comprises a direct-heating device.

21. The system of claim 20 wherein said heating device is a gas burner.

22. The system of claim 17 wherein said heating device comprises an indirect heating device.

23. The system of claim 22 wherein said heating device is a heat exchanger.

24. The system of claim 17 wherein said heating device heats said gaseous effluent to a temperature above the saturation temperature of the gaseous effluent.

25. The system of claim 17 wherein said filtering device comprises a baghouse.

26. A molten salt treatment system comprising:
a molten salt reactor comprising a vessel capable of containing a molten salt, said vessel flowably attached to a reactor overflow outlet;
an overflow conduit flowably connected to the reactor overflow outlet to receive molten salt therefrom and discharge the molten salt to a salt recovery vessel; and
a gas mover flowably connected to the molten salt reactor and the salt recovery vessel and capable of preventing backflow of cold gases through the overflow conduit to the molten salt reactor.

27. The system of claim 26 wherein the gas mover comprises a superheated steam injector.

28. The system of claim 26 wherein said molten salt reactor further comprises a splash shield positioned at said overflow conduit.

29. The system of claim 26 wherein said overflow conduit is sloped back toward said molten salt reactor.

30. The system of claim 26 further comprising a heating device connected to introduce hot gas into said overflow conduit.

31. The system of claim 30 wherein said heating device comprises a direct heating device.

32. The system of claim 31 wherein said direct heating device is a gas burner.

33. The system of claim 30 wherein said heating device comprises an indirect heating device.

34. The system of claim 33 wherein said indirect heating device is a heat exchanger.

35. The system of claim 26 further comprising a salt dissolution device flowably connected to receive the molten salt from the reactor, dissolve the salt in water, and transport the salt to the salt recovery vessel.

36. The system of claim 35 wherein said salt dissolution device comprises a sluice line.

37. The system of claim 26 further comprising one or more directional superheated steam injectors located to impinge and break up molten salt issuing from said overflow conduit and to direct the molten salt to the salt recovery vessel.

38. The system of claim 26 wherein said gas mover comprises a blower having a low pressure side flowably connected to the salt recovery vessel and a high pressure side flowably connected to the molten salt reactor.

39. A molten salt treatment system comprising:
a molten salt reactor comprising a vessel capable of containing a molten salt, said vessel flowably attached to an off gas outlet and to a reactor overflow outlet;
one or more tubular conduits flowably connected to the molten salt reactor, each of said tubular conduits containing concentrically within it a corresponding pipe or shaft so as to form an annular space therebetween;
one or more gas sources connected to feed a gas through the annular space in at least one of said tubular conduits into the reactor;
a scrubbing device flowably connected to the off-gas outlet to receive therefrom an off-gas containing entrained salt;
a first heating device configured to heat a gaseous effluent from the scrubbing device;
a filtering device flowably connected to receive said gaseous effluent heated by said heating device;
an overflow conduit flowably connected to the reactor overflow outlet to receive molten salt therefrom and discharge the molten salt to a salt recovery vessel; and
a gas mover flowably connected to said molten salt reactor and the salt recovery vessel capable of preventing backflow of cold gases through the overflow conduit to said molten salt reactor.

40. The system of claim 39 wherein said one or more tubular conduits is connected to said molten salt reactor at a location below a liquid level of molten salt in said molten salt reactor.

41. The system of claim 39 further comprising a first sealing device at an upstream location in at least one of said one or more tubular conduits, and a second sealing device in said at least one tubular conduit at a downstream location.

42. The system of claim 41 wherein said second sealing device is a valve having open and closed positions.

43. The system of claim 42 wherein said first sealing device comprises a packing gland.

44. The system of claim 39 wherein said tubular conduit further comprises a stop limit in a portion of said one or more tubular conduits.

45. The system of claim 44 wherein said stop limit comprises a coupling.

46. The system of claim 39 wherein in at least one of said one or more tubular conduits, said pipe or shaft is a pipe connected to a feed source to feed a material to said molten salt reactor.

47. The system of claim 46 wherein said one or more gas sources feed a gas into said at least one tubular conduit at a pressure sufficient to prevent backflow of molten salt into said tubular conduit.

48. The system of claim 46 wherein said material comprises halogenated waste material.

49. The system of claim 48 wherein said material comprises chlorinated waste material from a sucralose manufacturing process.

50. The system of claim 39 wherein said pipe or shaft is a shaft.

51. The system of claim 50 wherein said pipe or shaft comprises a drill bit mounted onto a downstream end of said pipe or shaft.

52. The system of claim 39 wherein said one or more tubular conduits comprise at least one tubular conduit concentrically containing a pipe and at least another tubular conduit concentrically containing a shaft.

53. The system of claim 39 wherein said gas comprises air.

54. The system of claim 39 further comprising an evaporating device flowably connected to said one or more tubular conduits upstream of said one or more tubular conduits.

55. The system of claim 39 wherein said pipe or shaft is a pipe connected to receive molten salt discharged from said molten salt reactor and to discharge the molten salt to the salt recovery vessel.

56. The system of claim 39 wherein said scrubbing device is a water scrubber.

57. The system of claim 39 wherein said scrubbing device comprises a venturi scrubber.

58. The system of claim 57 wherein said first heating device comprises a direct-heating device.

59. The system of claim 54 wherein said first heating device is a gas burner.

60. The system of claim 39 wherein said first heating device comprises an indirect heating device.

61. The system of claim 60 wherein said first heating device is a heat exchanger.

62. The system of claim 39 wherein said first heating device is capable of heating said gaseous effluent to a temperature above the saturation temperature of the gaseous effluent.

63. The system of claim 39 wherein said filtering device comprises a baghouse.

64. The system of claim 39 wherein the gas mover comprises a superheated steam injector.

65. The system of claim 39 wherein said molten salt reactor further comprises a splash shield positioned at said overflow conduit.

66. The system of claim 39 wherein said overflow conduit is sloped back toward said molten salt reactor.

67. The system of claim 39 further comprising a second heating device connected to introduce hot gas into said overflow conduit.

68. The system of claim 67 wherein said second heating device comprises a direct heating device.

69. The system of claim 68 wherein said second heating device is a gas burner.

70. The system of claim 67 wherein said second heating device comprises an indirect heating device.

71. The system of claim 70 wherein said second heating device is a heat exchanger.

72. The system of claim 39 further comprising a salt dissolution device flowably connected to receive the molten salt from said heating device and connected to transport dissolved salt to the salt recovery vessel.

73. The system of claim 72 wherein said salt dissolution device comprises a sluice line.

74. The system of claim 39 further comprising one or more directional superheated steam injectors configured to receive molten salt from said overflow conduit and to direct the molten salt to the salt recovery vessel.

75. The system of claim 39 wherein said gas mover comprises a blower having a low pressure side flowably connected to the dissolution vessel and a high pressure side flowably connected to said molten salt reactor.

76. A process for treating a material in a molten salt reactor, said reactor comprising a vessel containing a molten salt, the process comprising the steps of:
delivering the material via a pipe concentrically contained within a tubular conduit flowably connected to the molten salt reactor, said pipe and conduit forming an annular space therebetween; and
injecting a gas into the annular space, the gas having a pressure sufficient to prevent molten salt from backflowing out of the molten salt reactor into the annular space.

77. The process of claim 76 further comprising the step of removing a solvent from the material in an amount sufficient to prevent overpressurization when the material is introduced into the molten salt reactor under operating conditions.

78. The process of claim 77 wherein said solvent is water.

79. The process of claim 78 wherein the step of removing a solvent comprises evaporating the water from the material.

80. The process of claim 76 further comprising the step of heating the material prior to delivering the material to the molten salt reactor.

81. The process of claim 76 wherein the gas comprises air.

82. A process for treating off-gas from a molten salt reactor, said reactor comprising a vessel containing a molten salt, the process comprising the steps of:
scrubbing an off-gas containing solid particulate matter discharged from the molten salt reactor with an aqueous stream to remove at least a portion of the particulate matter and produce a moisture-containing gaseous effluent;
heating the moisture-containing gaseous effluent; and
filtering the effluent to remove remaining entrained solid particulate matter.

83. The process of claim 82 wherein said scrubbing step comprises scrubbing with a venturi scrubber.

84. The process of claim 82 wherein the solid particulate matter comprises particles of a salt.

85. The process of claim 82 wherein the step of heating the moisture-containing gaseous effluent includes heating a water saturated gaseous effluent to a temperature above a saturation temperature of the effluent.

86. The process of claim 82 further comprising venting the gaseous effluent to the atmosphere.

87. A process for discharging molten salt from a molten salt reactor, said reactor comprising a vessel containing a molten salt, the process comprising the steps of:
heating or maintaining a temperature of a molten salt stream discharged from the molten salt reactor to a salt recovery vessel to maintain the molten salt stream in a molten state; and
operating a gas mover to prevent backflow of cold gases to the molten salt reactor.

88. The process of claim 87 further comprising dissolving the molten salt stream in water prior to introducing the salt to the salt recovery vessel.

89. The process of claim 88 wherein the step of dissolving the molten salt overflow stream includes dissolving the molten salt in water in a sluice line.

90. The process of claim 87 further comprising the step of directing the molten salt overflow stream to the salt recovery vessel using one or more directional superheated steam injectors.

91. The process of claim 87 wherein said step of generating conditions comprises generating a pressure, temperature or combination thereof to prevent backflow of cold gases to the molten salt reactor.

92. The process of claim 87 wherein the step of generating a pressure comprises generating a low pressure in the dissolution recovery vessel and a high pressure in the molten salt reactor with a blower.

93. The process of claim 87 further comprising recovering salt from the molten salt reactor as a salt solution.

94. The process of claim 87 further comprising recovering salt from the molten salt reactor as a solid.

95. The process of claim 87 further comprising maintaining a splash shield at an outlet of said molten salt reactor.

96. The process of claim 87 further comprising limiting flow discharged from said molten salt reactor via a restriction neck downstream of said molten salt reactor.

97. A process for treating a material in a molten salt reactor, said reactor comprising a vessel containing a molten salt and said vessel flowably connected to a reactor overflow outlet, the process comprising the steps of:
delivering the material to the molten salt reactor via a pipe concentrically contained within a tubular conduit flowably connected to the reactor, said pipe and said conduit forming an annular space therebetween;
injecting a gas into the annular space, the gas having a pressure sufficient to prevent molten salt from backflowing out of the molten salt reactor into the tubular conduit or the pipe;
scrubbing an off-gas containing solid particulate matter discharged from the molten salt reactor with an aqueous stream to remove at least a portion of the particulate matter and produce a moisture-containing gaseous effluent;
heating the moisture-containing gaseous effluent;
filtering the effluent to remove remaining entrained solid particulate matter;
discharging molten salt from the reactor to a salt recovery vessel through an overflow conduit flowably connected to the reactor overflow outlet; and
operating a gas mover flowably connected to the molten salt reactor and the salt recovery vessel to prevent backflow of cold gases through the overflow conduit to the molten salt reactor.

98. The process of claim 97 further comprising the step of removing a solvent from the material in an amount sufficient to prevent overpressurization when the material is introduced into the molten salt reactor under operating conditions.

99. The process of claim 98 wherein said solvent is water.

100. The process of claim 98 wherein the step of removing a solvent comprises evaporating the water from the material.

101. The process of claim 97 further comprising the step of heating the material prior to delivering the material to the molten salt reactor.

102. The process of claim 97 further comprising the step of maintaining an airlock in a portion of the tubular conduit.

103. The process of claim 97 wherein the gas comprises air.

104. The process of claim 97 wherein the scrubbing step comprises scrubbing with a water scrubber.

105. The process of claim 97 wherein said scrubbing step comprises scrubbing with a venturi scrubber.

106. The process of claim 97 wherein the solid particulate matter comprises salt.

107. The process of claim 97 wherein the step of heating the moisture-containing gaseous effluent includes heating a water saturated gaseous effluent to a temperature above a saturation temperature of the effluent.

108. The process of claim 97 further comprising venting the gaseous effluent to atmosphere.

109. The process of claim 97 further comprising dissolving the molten salt stream in water prior to introducing the salt to the salt recovery vessel

110. The process of claim 109 wherein the step of dissolving the molten salt overflow stream includes dissolving the molten salt in water in a sluice line.

111. The process of claim 97 further comprising the step of directing the molten salt overflow stream to the salt recovery vessel using one or more directional superheated steam injectors.

112. The process of claim 97 wherein said step of generating conditions comprises generating a pressure, temperature or combination thereof to prevent backflow of cold gases to the molten salt reactor.

113. The process of claim 97 wherein the step of generating conditions comprises generating a low pressure in the salt recovery vessel and a high pressure in the molten salt reactor with a blower.

114. The process of claim 97 further comprising recovering salt from the molten salt reactor in a salt solution.

115. The process of claim 97 further comprising recovering salt from the molten salt reactor as a solid.

116. The process of claim 97 further comprising limiting flow discharged from said molten salt reactor via a restriction neck downstream of said molten salt reactor.

117. The system of claim 9 further comprising a nozzle on the downstream end of the pipe, said nozzle comprising a plurality of passages passing from the upstream end of the nozzle into the interior of the pipe and terminating near the downstream end thereof.

118. The system of claim 9 wherein the passages are oriented in an inwardly twisting direction.

119. The system of claim 1 further comprising a shield surrounding at least a portion of the vessel, located and shaped so as to define an annular ventilation space between the shield and the vessel.

120. The process of claim 76 further comprising introducing a combustible gas or vapor into the reactor below or above a surface of the molten salt, or both.

121. A process for treating a material in a molten salt reactor, said reactor comprising a vessel containing a molten salt, the process comprising the steps of:
delivering the material into the reactor; and
discharging molten salt from the reactor through a pipe to a salt recovery vessel, said pipe contained concentrically within a tubular conduit flowably connected to the reactor, said pipe and conduit forming an annular space therebetween; and
injecting a gas into the annular space, the gas having a pressure sufficient to prevent molten salt from backflowing out of the molten salt reactor into the annular space.
